(19) United States
(12) Patent Application Publication
(10) Pub. No.: US 2011/0145373 A1
(43) Pub. Date: Jun. 16, 2011

(54) SYSTEMS AND METHODS FOR CONFIGURING COMMUNICATION BETWEEN MEDICAL DEVICES

(76) Inventors: SINAN ANWAR AWAD, HAIFA (IL); EINAT KATZ, HAIFA (IL)

(21) Appl. No.: 12/637,328

(22) Filed: Dec. 14, 2009

(51) Int. Cl. G06F 15/16; G06F 15/177

(52) U.S. Cl. 709/220; 709/228; 709/237

(57) ABSTRACT

Systems and methods for configuring communication between medical devices are provided. One method includes transmitting a broadcast query via the medical network from a local device to a plurality of remote devices and receiving a response from at least one of the plurality of remote devices identifying communication parameters for the remote device. The method further includes configuring communication between the local device at the at least one remote device at the local device based on the received communication parameters from the remote device.

### BACKGROUND OF THE INVENTION

The subject matter disclosed herein relates generally to medical devices, such as medical scanners and associated components, and more particularly to systems and methods for configuring the medical devices for communication therebetween.

In medical environments, a number of different devices are interconnected for communication of control commands and information, such as acquired image information. For example, a plurality of diagnostic imaging scanners, user interfaces, servers, etc. may be interconnected for communication, such as within a hospital or other medical building. The devices may communicate using one or more protocols or standards.

When a new medical device is installed, the medical device needs to be configured such that the device includes the necessary communication parameters for communicating with other devices, such as other devices in the medical network (e.g., hospital network). Thus, the new device must be communicatively coupled to the other devices in the network. In these instances, such as in the case of a new device installation, field engineers and/or users have to configure the devices (e.g., processing station or medical scanner) by being physically present at the device location and entering configuration parameters in the device. Thereafter, the other interconnected devices (e.g., the other already present network connected devices) also have to be configured in a similar manner by the field engineer and/or user physically going to those devices and entering associated configuration parameters. This configuration process is time consuming and can increase the likelihood of errors, such as the field engineer or user typing in the wrong information at one of the physical sites.

### BRIEF DESCRIPTION OF THE INVENTION

In accordance with various embodiments, a method for configuring communication between devices within a medical network is provided. The method includes transmitting a broadcast query via the medical network from a local device to a plurality of remote devices and receiving a response from at least one of the plurality of remote devices identifying communication parameters for the remote device. The method further includes configuring communication between the local device at the at least one remote device at the local device based on the received communication parameters from the remote device.

In accordance with other embodiments, a computer readable medium for configuring a medical device is provided. The computer readable medium is programmed to instruct a computer to determine from a local medical device a plurality of remote medical devices connected to a medical network and receive at the local medical device a user input identifying remote medical devices to configure for communication with the local medical device. The computer readable medium is further programmed to instruct the computer to perform a handshake to configure communication parameters to provide communication between the local medical device and at least one of the plurality of remote medical devices.

In accordance with yet other embodiments, a medical system is provided that includes a plurality of medical devices interconnected via a medical network and a user interface accessible at a local one of the plurality of medical devices. The user interface is configured to identify other medical devices remote from the local medical device and receive a user authorization input to cause a processor to complete a handshake between the local medical device an at least one of the remote medical devices to configure communication therebetween.

### BRIEF DESCRIPTION OF THE DRAWINGS

FIG. 1 is a simplified block diagram of a plurality of interconnected medical devices that may be configured for communication in accordance with various embodiments.

FIG. 2 is a flowchart of a method for configuring a medical device to communicate with other medical devices in a network in accordance with various embodiments.

FIG. 3 is a diagram illustrating a plurality of different imaging systems that may be configured for communication in accordance with various embodiments.

FIG. 4 is a diagram illustrating a network topology with a plurality of devices that may be configured for communication in accordance with various embodiments.

FIG. 5 is a diagram illustrating a configuration sequence performed in accordance with various embodiments.

FIG. 6 is a diagram of a user interface formed in accordance with various embodiments.

### DETAILED DESCRIPTION OF THE INVENTION

The foregoing summary, as well as the following detailed description of certain embodiments will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (e.g., processors or memories) may be implemented in a single piece of hardware (e.g., a general purpose signal processor or random access memory, hard disk, or the like) or multiple pieces of hardware. Similarly, the programs may be stand alone programs, may be incorporated as subroutines in an operating system, may be functions in an installed software package, and the like. It should be understood that the various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

Various embodiments provide systems and methods for configuring medical devices for communication, and in particular, configuring the devices for interconnection to communicate with each other. For example, the methods described herein configure an imaging system at a local medical device to provide communication with other remote medical devices. At least one technical effect of the various embodiments is allowing multiple medical devices to be configured for communication from a single medical device that is being configured. Configuration of multiple devices from a single device location can reduce time and cost for the process.

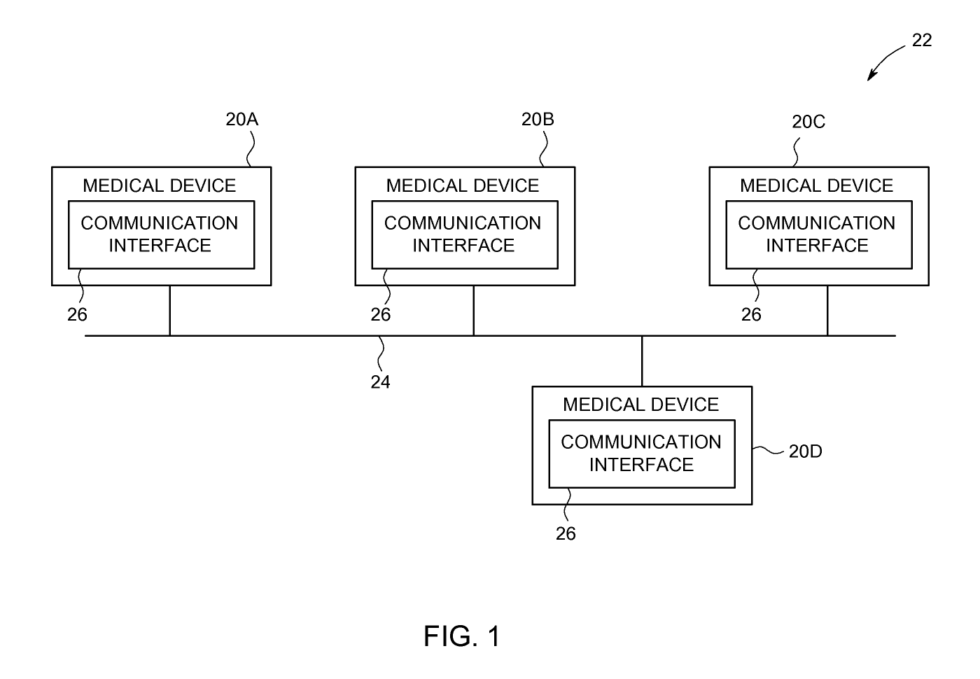

In particular, the various embodiments provide for configuring one or more medical devices 20 as shown in FIG. 1 for communication with other medical devices 20 that are interconnected. One or more of the medical devices 20 may be a newly installed or updated device that needs configuring to communicate with the other medical devices 20. For example, a network 22 may be provided that interconnects the medical devices 20. In some embodiments, the medical devices 20 are Digital Imaging and Communications in Medicine (DICOM) devices interconnected via a local area network (LAN) 24. Accordingly, the various embodiments may configure DICOM-compatible diagnostic imaging equipment connected to a LAN 24 for communication from a single device location, such as from a single newly installed local medical device. It should be noted that the medical devices 20 may be any kind or type of medical device. For example, the medical devices 20 may be one of medical scanners, workstations, storage devices, printers, etc.

It should be noted that when reference is made herein to scanners in a diagnostic medical system, scanners include generally medical diagnostic data acquisition equipment, not necessarily limited to equipment for image data acquisition, but also including other services and devices, such as Picture Archiving and Communication Systems (PACS) devices, image management systems, facility or institution management systems, viewing systems, storage systems, control systems and the like, in the field of medical diagnostics. Accordingly, equipment or devices as used herein include imaging systems, clinical diagnostic systems and physiological monitoring systems, among others.

In some embodiments, the medical devices 20 are a plurality of diagnostic imaging systems, each having a communication interface 26, for example, configured as a DICOM interface, which converts files into objects formatted in accordance with DICOM standards. Thus, for example, if one of the medical devices 20c is a new imaging scanner, the various embodiments configure the medical device 20c (at the local site of the medical device 20c) to communicate with at least one or the other medical devices 20, for example, medical device 20a, 20c or 20d, which may be remote devices, such a diagnostic imaging scanner, a storage device, a printer, a server, etc. Once configured as described herein, the medical device 20c can communicate, for example, images in DICOM format from a scanner to a storage device via the LAN 24. It should be noted that the DICOM data communications generally include a header having the address of the transmitting device and the address of the destination receiving device. In operation, the transmitting device sends the DICOM data communication to the LAN 24, and the receiving device recognizes the address corresponding to that device in the header of the DICOM data communication and then acquires the DICOM data communication from the LAN 24. Thus, the medical devices 20 in accordance with various embodiments may be DICOM compatible such that the medical devices 20 can send and receive DICOM objects to and from other medical devices 20 connected via the LAN 24 when each is configured with the proper communication parameters.

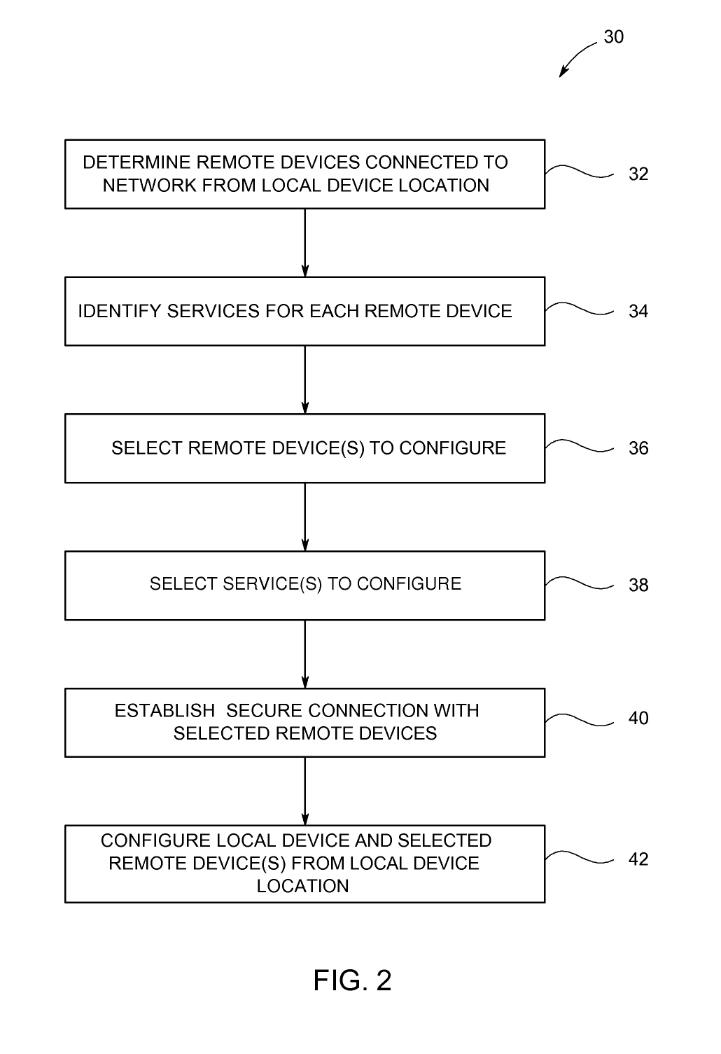

In accordance with various embodiments, a method 30 as shown in FIG. 2 is provided for configuring a medical device to communicate with other medical devices in a network. The method 30 allows, for example, for configuration of a newly installed medical device to communicate with other medical devices locally from the location of the newly installed medical device. Specifically, a determination is made at 32 as to the medical devices connected to the network. The determination is made from a single location, such as at the local location of the newly installed device using, for example, a user interface (UI) of the newly installed device as described in more detail herein. For example, on a client side (wherein the newly installed device is the client and a network controller may operate as the server), a query is broadcast in initiated requesting other available devices to respond. The query may be formatted in any suitable manner, for example, as a DICOM query. The broadcast query in various embodiments identifies the client, for example, as a proprietary client, such as using an encrypted payload with a signed user identification (UID). A list of connected medical devices thereafter may be provided via the UI based on responses to the broadcast query or optionally based on a previously obtained list that was acquired by scanning the network, for example, using a DICOM device search object.

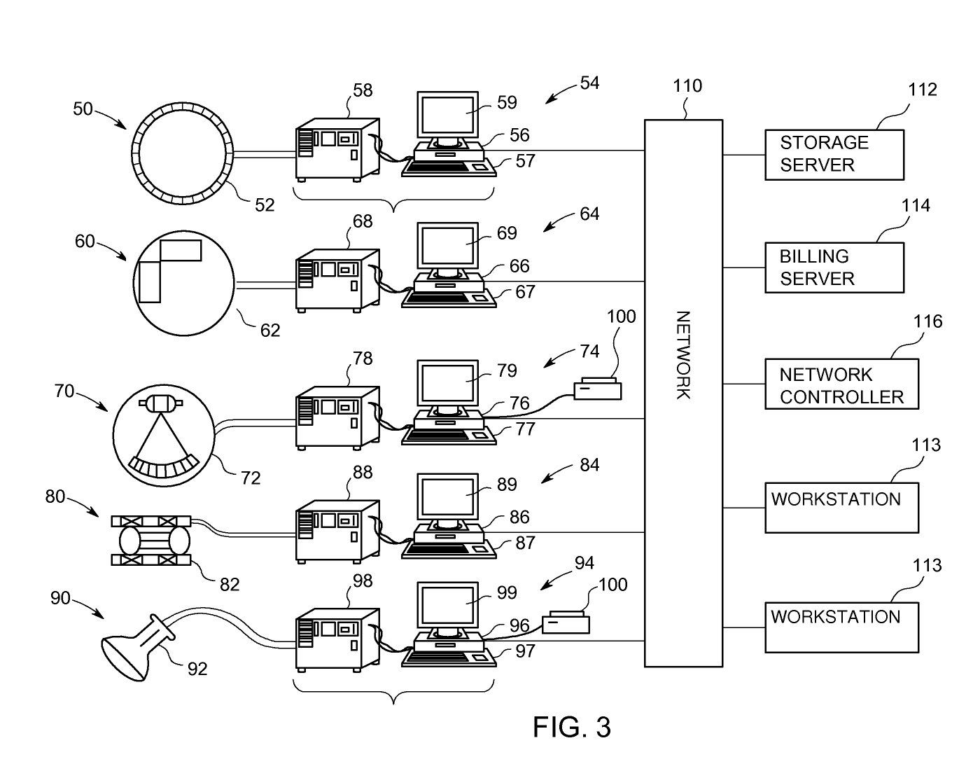

For example, as shown in FIG. 3, one or more different types of medical scanners, as well as associated user interfaces and peripherals may be interconnected, which are identified at 32 of the method 30 in FIG. 2. In particular, the medical devices may generally include a positron emission tomography (PET) system 50, a single photon emission computed tomography (SPECT) system 60, an x-ray computed tomography (CT) system 70, a magnetic resonance imaging (MRI) system 80 and an ultrasound system 90. However, it should be noted that different numbers of and other types of systems or components may be provided. The diagnostic medical imaging systems illustrated may form part of a hospital and may be located in different rooms, on different floors, in different buildings, on different campuses, etc. Thus, the medical devices or systems may be positioned in a single location or facility, such as a medical facility, or may be in different locations from one another. The medical imaging systems also may be connected to a centralized control system or other controller. Moreover, depending on the type of medical imaging system, namely the imaging modality, different subcomponents or subsystems are provided.

For example, the PET system 50 includes a PET scanner 52, the SPECT system 60 includes a SPECT scanner 62, the x-ray CT system 70 includes a CT scanner 72, the MRI system 80 includes an MRI scanner 82 and the ultrasound system 90 includes an ultrasound probe 92. Each of the scanners includes one or more detectors or image acquiring or detecting components as is known in the art. It should be noted that the representations of each of the scanners in FIG. 3 is a simplified representation of the components thereof and used herein for ease of identification.

Each of the imaging systems also includes a processing portion 54, 64, 74, 84 and 94 having a respective user console 56, 66, 76, 86 and 96 (e.g., a workstation) that communicates with a respective scanner 52, 62, 72, 82 and 92 to transmit control commands and receive image information through a control interface 58, 68, 78, 88 and 98. For example, the user consoles 56, 66, 76, 86 and 96, which may include one or more processing units may generate control signals for controlling the a respective scanner 52, 62, 72, 82 and 92 based on, for example, user inputs or a predetermined scan or may perform a communication configuration process as described in more detail herein. The processors and associated hardware and software used to acquire and process data may be collectively referred to as the user consoles 56, 66, 76, 86 and 96. The user consoles 56, 66, 76, 86 and 96 each include one or more user input devices 57, 67, 77, 87 and 97, illustrated as a keyboard, but may also include a mouse, a pointer, and the like. A monitor 59, 69, 79, 89 and 99 that displays image data and may accept input from a user if a touchscreen is available is also provided. The user consoles 56, 66, 76, 86 and 96 may also be used to configure the respective scanner 52, 62, 72, 82 and 92 for communication with each other as described in more detail herein.

Additional components may be included in imaging systems, for example a printer 100, shown in the CT imaging system 70 and the ultrasound system 90, which may produce reconstructed images based upon data collected from the CT scanner 72 and the ultrasound probe 92, respectively.

Each of the imaging systems 50, 60, 70, 80 and 90 are interconnected via a network 110. Additionally, the medical devices may include other types of devices, for example, a storage server 112, a billing server 114 or other workstations 113 that are interconnected with the imaging systems 50, 60, 70, 80 and 90 via the network 110. It should be noted that the network may include wired or wireless communication links, or a combination thereof. It also should be noted that additional components may be provided, for example, additional consoles, workstations or servers.

The network 110 may be provided using different configurations or topologies, such as proprietary or dedicated networks, as well as open networks, such as a Wide Area Network (WAN) using, for example, secure private network tunneling, etc. Data may be exchanged using different formats, for example, a DICOM format, and in accordance with different protocols.

Each of the imaging systems 50, 60, 70, 80 and 90 is uniquely identified, for example, using information stored within the systems or associated components, such as within a memory in or associated with the user consoles 56, 66, 76, 86 and 96. For example, each of the imaging systems 50, 60, 70, 80 and 90 may include a communication interface, for example, the communication interface 26 (shown in FIG. 1) that allows for communication via the network, and having associated identification information stored within the imaging systems 50, 60, 70, 80 and 90. For example, a storage medium may be provided in connection with a microcontroller of the user consoles 56, 66, 76, 86 and 96. The storage medium may be any type of memory component that allows for the reading and writing of non-volatile data, such as, RAM (random access memory), an EPROM (electrically programmable read only memory) and/or an EEPROM (electrically-erasable programmable read only memory). In some embodiments, the storage medium includes a readable/writeable memory module such that the microcontroller coupled to the storage medium is responsive to requests for identification information from a network controller 116 (or other device) via the network 110.

The storage medium contains information both generic and specific to the imaging systems 50, 60, 70, 80 and 90. For example, the information may include communication parameters and/or protocol information and/or device specific information such as operating model identification information, including model number, serial number, and manufacturing date, as well as services available and operating characteristics. Similar information may be stored in connection with the other network connected devices, such as the printers 100, storage server 112, workstations 113 and billing server 114.

Thus, for example, and referring the method 30 of FIG. 2, the devices connected to the network may be identified based on stored information within each of the imaging systems (e.g., within the storage medium) and which may have been previously acquired by the network controller 116. The information is acquired at one of the imaging systems (such as a local device), for example, using the user console 56 of the PET system 50, which may be a newly installed system or user console 56. It should be noted that more than one user console may be connected and associated with each imaging system.

Referring again to FIG. 1, after the medical devices are determined, which includes a determination of the devices interconnected on the network, the services for each are identified at 34. For example, the services identified may include the scanning capabilities for each imaging system or the storage or billing capabilities of the servers. The identified services may include any types of services, for example, DICOM services, hardcopy services, filming services, etc. It should be noted that the determined devices may be filtered by the available services as described in more detail herein.

In some embodiments, after a broadcast query is transmitted to identify the available devices at 32, the connected devices authenticate the client (e.g., authenticate that the client is a proprietary client), and if authenticated, the devices send a query response with identification and communication parameter information (which may be stored in a storage medium thereof as described in more detail above). Additionally, a list of available services for each of the devices may be provided as part of the query response. The communication parameters allow for configuration of communication between the devices, for example, between the newly installed device and other devices as described in more detail herein.

Thereafter, one or more devices are selected at 36 to be configured to allow communication between the newly installed device and the selected devices. Additionally, one or more services of the selected devices may be selected to be configured at 38. For example, the client, which may include a UI or application at the local newly installed device, may be provided to allow a user to select the devices and corresponding services to be configured.

Once the devices have been selected (along with the associated services), a secure connection is established at 40 between the client (at the newly installed medical device) and the one or more selected medical devices. It should be noted that client as used herein generally refers to an application or device that may access a remote service on another device or system. The secure connection may be established by a secure handshake with the one or more selected devices (using any standard authentication protocol). A handshake is generally an automated process of negotiation that dynamically sets the parameters of a communication channel or link established between two devices or entities before normal communication over the channel or link begins. The handshake is performed after the physical establishment of the channel connection and before normal information transfer.

Thereafter, at 42, the current device (e.g., local medical device) and selected devices (e.g., remote devices) are configured for communication. For example, in some embodiments, a user (e.g., field engineer) authorizes the local device, namely the newly installed device at which the user is physically located to complete a handshake with the other devices, such as the remote devices, and to thereby configure communication between the local device and the remote devices. For example, if the devices are DICOM stations, a DICOM Application Entity and Transmission Control Protocol (TCP) Port information for each of the devices may be used to complete the handshake and configure communication between the local device and each of the remote devices. An Application Entity (AE) may be a local or remote DICOM service. For example, in an image archiving system, DICOM services may include storage and query/retrieve. The devices (e.g., local or remote imaging equipment or computers) may support one or more services, and one or more service roles. Roles generally define a device as a service class user (SCU) or a service class provider (SCP). A SCU role is typically associated with a client action and an SCP role is typically associated with a server action.

It should be noted that a DICOM message generally includes a command set and data set. It also should be noted that the communication configuration between the local device and the remote devices and may be performed using any suitable method for establishing such communication between the devices. In various embodiments, a handshake type process to authorize communication therebetween is provided.

It should be noted that optionally the local device client may also communicate transitively with devices that are already configured on the remote devices. For example, when the local device communicates with each of the remote devices, the local device can also configure communication with devices configured to communicate with the remote device, such as configuring communication with a printer that is configured on the remote device.

It also should be noted that although the method 30 is described as communicating over a secure connection, other types of connections may be used. For example, in some embodiments, a clear text transmission may be used to communicate between the local device and the remote devices.

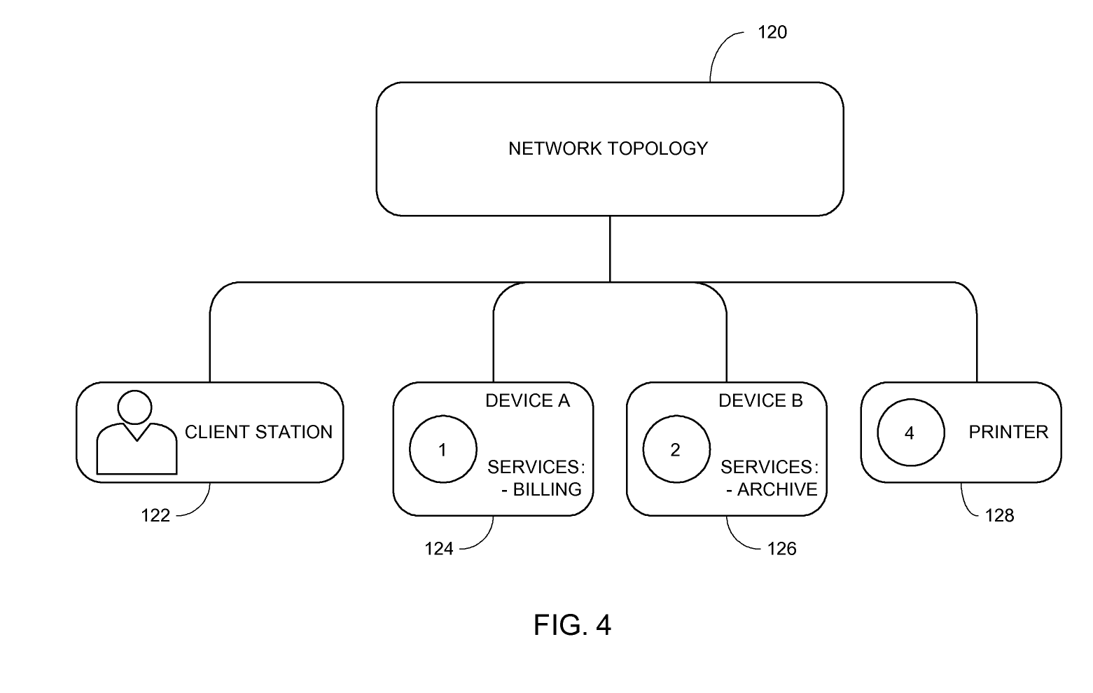

Thus, a shown in FIG. 4, the various embodiments may configure communication between a plurality of devices, in particular medical devices, in a network architecture having a network topology 120. For example, the local device is represented as a client station 122 (e.g., a DICOM station) and the remote devices 124, 126 and 128 are represented as different types of devices and/or devices providing different services. For example, device 124 (Device A) is illustrated as a device providing billing services and device 126 (device B) is illustrated as a device providing archive services. Accordingly, each of the devices 124 and 126 may be a personal computer (PC), server or other computing device. For example, the device 126 may be a PACS device. As illustrated, the device 128 is a printer, which may be connected to one or more of the devices 124 and 126.

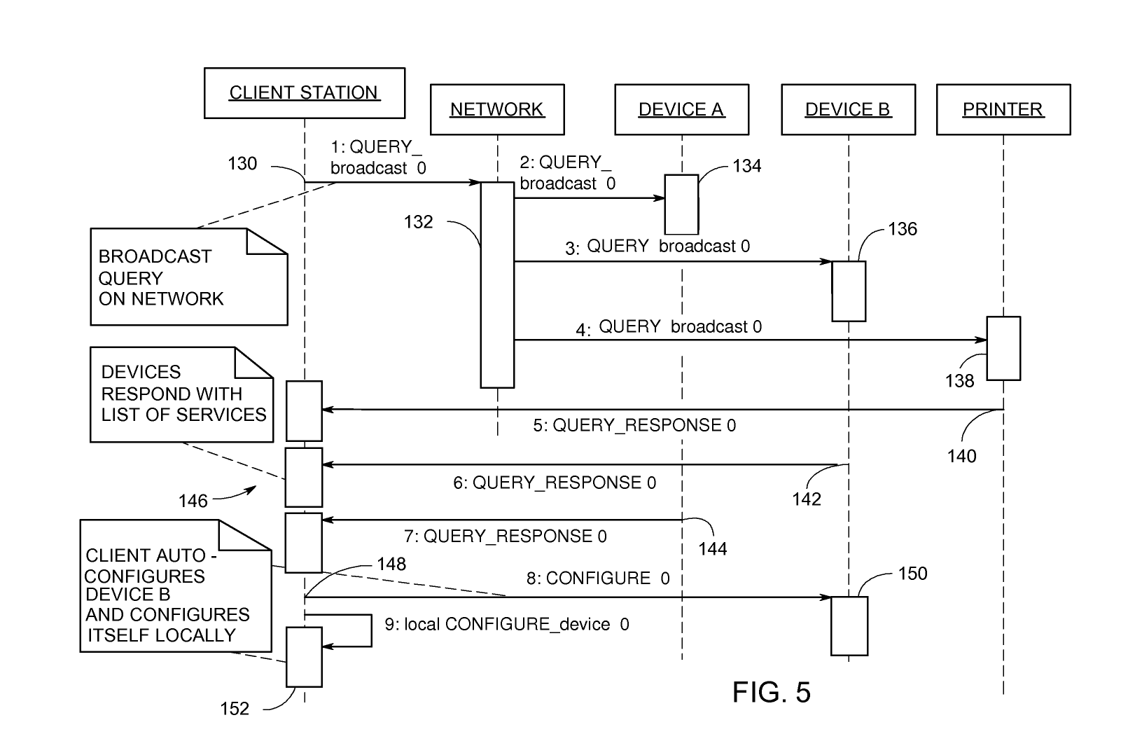

Accordingly, a configuration sequence, which may be provided as a secure handshake is illustrated in FIG. 5, which continues with the example from FIG. 4. In particular, at 130, a client station, such as a UI on a local device sends a query broadcast, for example, queries all devices on the network. In some embodiments, the broadcast query is initiated by a user at a local device, which is a newly installed device, and needs to be configured for communication with other devices on the network. It should be noted that the devices to query may be filtered, for example, by indicating via the UI (as described in more detail below), that certain services are desired or not desired. Accordingly, devices having the desired services will respond to the broadcast query and devices having services that are not desired with not respond to the broadcast query. In other embodiments, all devices are identified and the devices to be configured are filtered based on desired services. In yet other embodiments, all identified devices are configured.

After the client initiates the broadcast query to identify remote devices, the network communicates the broadcast query, for example, using the network topology 120 (shown in FIG. 4), such as communication over a LAN. In some embodiments, a list of network devices is previously determined using any suitable device search process. It should be noted that the broadcast query is communicated over the network such that each of the devices receives (or sees) the broadcast query, which in this embodiment includes Device A, Device B and a Printer. Accordingly, at 134, 136 and 138, each of Device A, Device B and the Printer, respectively, receives the broadcast query and determines whether the device should respond. For example, each of Device A, Device B and the Printer authenticate the broadcast query and also may determine whether that device includes any of the desired services (if applicable). It should be noted that in the illustrated embodiment, each of Device A, Device B and Printer authenticate the broadcast query (which may be based also on a determination that each have at least one desired service). However, if no filtering is used, all devices will respond, which is illustrated in FIG. 5.

Thereafter, at 140, 142 and 144, each of Device A, Device B and the Printer respond to the broadcast query with a query response. In particular, each of Device A, Device B and the Printer respond with a list of services for each, which is received at 146. Additional information is also provided, such as communication parameter information for each of Device A, Device B and the Printer. A determination is then made, for example, by a user at the local device, which of the devices to configure. In the illustrated example, a determination is made to configure Device B for communication with the local device, which may include configuration to allow communication therebetween to access all available services from Device B. Thus, at 148 the client at the local device sends a configure command (e.g., DICOM configuration command) to Device B, which may include a unique ID, and in some embodiments is a secure command. The configure command is received at 150 by Device B and at 152 by the local device. The configure command, accordingly, auto-configures Device B and the local device to allow communication therebetween, which may be accomplished by the completion of the handshake between the two devices and using the communication parameter information.

Accordingly, in various embodiments, a user enters or determines configuration parameters once at the local device, which then is configured to communicate with other remote devices on the network as described in more detail herein.

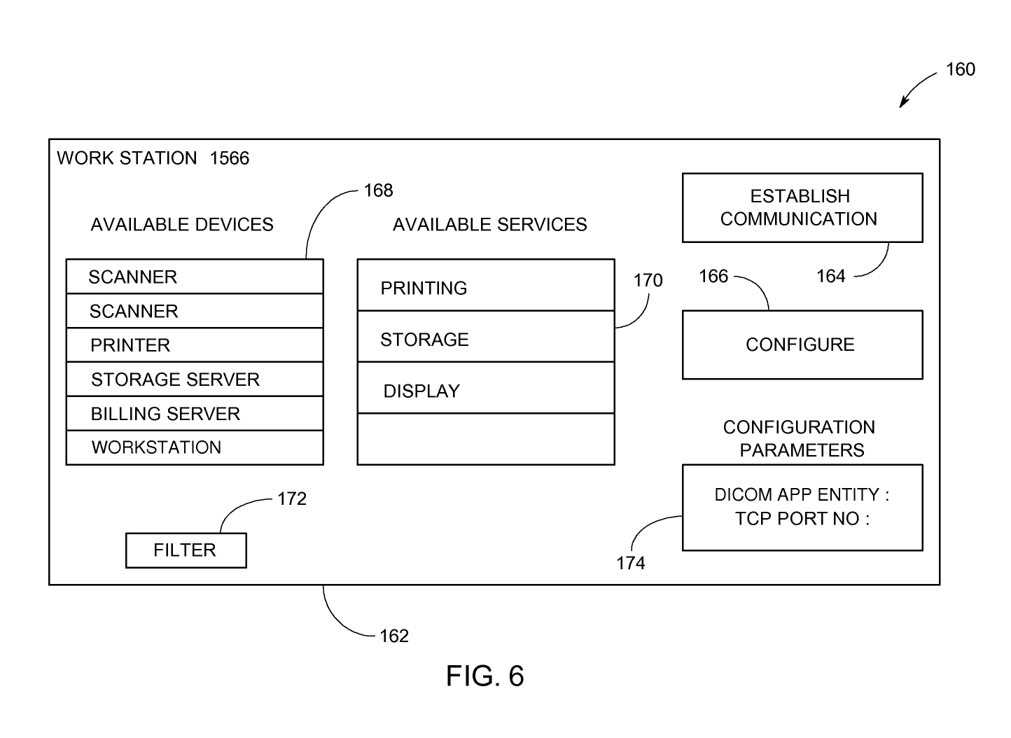

The configuration of a local device and remote devices from the local device may be accomplished with a UI 160 as illustrated in FIG. 6. The UI 160 may be displayed on a screen or display 162 of the local device and operate on the client side of a client-server communication as described in more detail herein. The UI 160 may be displayed, for example, on a screen of a newly installed workstation and include a plurality of selectable elements, for example, selectable by a user with a mouse or other user input. For example, an Establish Communication selectable element 164 and a Configure selectable element 166 are provided, which may be displayed on the display 162 as virtual buttons.

The Establish Communication selectable element 164, when selected operates to determine other devices, such as remote devices, on the network as described herein, such as initiated by a broadcast query. For example, one or more DICOM tasks (configured for communication with one or more remote devices) may be mapped to the Establish Communication selectable element 164. The results thereof are displayed in an Available Devices display portion 168, which may be configured as a list of available devices on the network. For example, the list may include each of a plurality of remote devices capable of being configured for communication with the local device. A user may select one of the devices from the list, which generates a list of available services in an Available Services display portion 170. It should be noted that the device results in the Available Devices display portion 168 may be filtered by selecting one or more of the service in the Available Services display portion 170. Alternatively, a Filter selectable element 172 may be provided, which when selected, provides a list of filtering options, for example, to filter the search results based on available services.

A user can then select devices to configure, and in particular, select from the list in the Available Devices display portion 168 the remote devices to configure for communication with local device. Thereafter, selection of the Configure selectable element 166 configures the local device and remote devices for communication using, for example, the handshake process described in more detail herein. The user may enter in a Configuration Parameters field 174 one or more configuration or communication parameters (e.g., DICOM application entity, TCP port number, etc.) used to configure the local device for communication with one or more remote devices identified in the Available Devices display portion 168. Additionally, the communication parameters for one or more remote devices may be automatically populated in the Configuration Parameters field 174.

Thus, in accordance with various embodiments, configuring interoperability between medical devices may be performed from a single location, for example, locally at a newly installed device location. Thus, a user does not need to manually configure each of a plurality of remote devices by physically entering configuration parameters in each of the remote devices, but can automatically configure the remote devices for communication with the local device at the local device. Additionally, once a device is configured for communication on the network, the configuration parameters for that device (or for a service) may be later accessed by another remote device to provide automatic configuration.

It should be noted that the various embodiments may be implemented in hardware, software or a combination thereof. The various embodiments and/or components, for example, the modules, or components and controllers therein, also may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as a floppy disk drive, optical disk drive, and the like. The storage device may also be other similar means for loading computer programs or other instructions into the computer or processor.

As used herein, the term “computer” or “module” may include any processor-based or microprocessor-based system including systems using microcontrollers, reduced instruction set computers (RISC), ASICs, logic circuits, and any other circuit or processor capable of executing the functions described herein. The above examples are exemplary only, and are thus not intended to limit in any way the definition and/or meaning of the term “computer”.

The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments of the invention. The set of instructions may be in the form of a software program. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to operator commands, or in response to results of previous processing, or in response to a request made by another processing machine.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments of the invention without departing from their scope. While the dimensions and types of materials described herein are intended to define the parameters of the various embodiments of the invention, the embodiments are by no means limiting and are exemplary embodiments. Many other embodiments will be apparent to those of skill in the art upon reviewing the above description. The scope of the various embodiments of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose the various embodiments of the invention, including the best mode, and also to enable any person skilled in the art to practice the various embodiments of the invention, including making and using any devices or systems and performing any incorporated methods. The patentable scope of the various embodiments of the invention is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

What is claimed is:

1. A method for configuring communication between devices within a medical network, the method comprising:
transmitting a broadcast query via the medical network from a local device to a plurality of remote devices;
receiving a response from at least one of the plurality of remote devices identifying communication parameters for the remote device; and
configuring communication between the local device at the at least one remote device at the local device based on the received communication parameters from the remote device.

2. A method in accordance with claim 1 further comprising receiving services information from the at least one remote device in response to the broadcast query.

3. A method in accordance with claim 2 further comprising configuring services for communication based on the received services information.

4. A method in accordance with claim 2 further comprising filtering the plurality of remote devices for configuring based on the received services information.

5. A method in accordance with claim 1 further comprising establishing a secure communication between the local device and the plurality of remote devices based on a device authentication.

6. A method in accordance with claim 1 wherein configuring communication comprises performing a handshake process between the local device and the at least one remote device.

7. A method in accordance with claim 1 wherein the communication parameters comprise Digital Imaging and Communications in Medicine (DICOM) communication parameters.

8. A method in accordance with claim 1 wherein the local device and the at least one remote device comprise Digital Imaging and Communications in Medicine (DICOM) devices.

9. A method in accordance with claim 1 wherein the local device is a newly installed medical device.

10. A method in accordance with claim 1 further comprising receiving other device information from the at least one remote device identifying additional devices with which the at least remote device is configured to communicate.

11. A method in accordance with claim 10 further comprising configuring communication with the additional devices based on the other device information.

12. A method in accordance with claim 1 wherein the local device and the at least one remote device comprise at least one of a medical scanner, a medical workstation, a medical server and a medical printer.

13. A method in accordance with claim 1 wherein the communication parameters comprise Digital Imaging and Communications in Medicine (DICOM) Application Entity and a Transmission Control Protocol (TCP) Port information.

14. A method in accordance with claim 1 wherein the local device and the at least one remote device comprise proprietary devices.

15. A computer readable medium for configuring a medical device, the computer readable medium being programmed to instruct a computer to:
determine from a local medical device a plurality of remote medical devices connected to a medical network;
receive at the local medical device a user input identifying remote medical devices to configure for communication with the local medical device; and
perform a handshake to configure communication parameters to provide communication between the local medical device and at least one of the plurality of remote medical devices.

16. A computer readable medium in accordance with claim 15 wherein the program further instructs the computer to establish a secure connection using an authentication process before performing the handshake.

17. A computer readable medium in accordance with claim 15 wherein the program further instructs the computer to determine services corresponding to each of the plurality of remote medical devices and receiving a user input at the local medical device identifying the services to configure.

18. A computer readable medium in accordance with claim 15 wherein the program further instructs the computer to use a Digital Imaging and Communications in Medicine (DICOM) broadcast query to determine the remote medical devices connected to the medical network.

19. A medical system comprising:
a plurality of medical devices interconnected via a medical network; and
a user interface accessible at a local one of the plurality of medical devices, the user interface configured to identify other medical devices remote from the local medical device and receive a user authorization input to cause a processor to complete a handshake between the local medical device an at least one of the remote medical devices to configure communication therebetween.

20. A medical system in accordance with claim 19 wherein the user interface is further configured to identify services associated with each of the plurality of remote medical devices and cause the computer to configure at least one of the services.
